(19) United States
(12) Patent Application Publication
(10) Pub. No.: US 2024/0044444 A1
(43) Pub. Date: Feb. 8, 2024

(54) Puzzle Support Platform

(71) Applicant: Xiaoyi CHE, Dangyang (CN)

(72) Inventor: Xiaoyi CHE, Dangyang (CN)

(21) Appl. No.: 18/094,793

(22) Filed: Jan. 9, 2023

(30) Foreign Application Priority Data
Aug. 5, 2022 (CN) 2022-220802132

(51) Int. Cl. F16M 11/26; F16M 11/42; F16M 11/20

(52) U.S. Cl. CPC F16M 11/26; F16M 11/42; F16M 11/2021; F16M 2200/027

(57) ABSTRACT

A puzzle support platform includes a platform, a base frame and a mounting frame which includes at least one support rod and at least one stabilizing leg. The platform is provided with a top surface for placing puzzle pieces thereon and a bottom surface for coupling with the mounting frame. The support rod and the stabilizing leg are arranged to form a stable triangular structure with the base frame, thereby providing a stable jigsaw puzzle game area.

### CROSS REFERENCE OF RELATED APPLICATION

This application is a non-provisional application that claims the benefit of priority under 35U.S.C.§ 119 to a Chinese application number CN2022220802132, filed Aug. 5, 2022, which is incorporated herewith by reference in its entirety.

### BACKGROUND OF THE PRESENT INVENTION

### Field of Invention

The present invention relates to the technical field of jigsaw puzzle accessories, and more particularly to a puzzle support platform.

### Description of Related Arts

Jigsaw puzzle, as a game or teaching tool, has been quite popular since it was invented. It is not only due to the low cost of manufacturing jigsaw puzzle, but also because of the diverse puzzle patterns, various numbers of the puzzle pieces, and other adjustable variables of the jigsaw puzzle games, which provide more playability. It is well known that jigsaw is beneficial to the brain and is often utilized as an intelligence-promoting game or educational enlightenment tool. Studies have shown that playing a puzzle can improve cognitive ability and visual spatial reasoning capability, as well as train attention and patience.

In general, the finished size of the jigsaw puzzle is relatively large, so that a relatively large game area such as a table or a puzzle board is required for the jigsaw game, so that all the puzzle pieces can be spliced together, and the player may need several hours, several days or even months to complete a jigsaw pattern, so that the player usually needs to prepare a special table or board as a dedicated game area. When a player challenge a large size jigsaw, it is necessary to prepare a table or puzzle board with sufficient bearing area, while the arm length of the player is often not sufficient to reach the entire game area, and the viewing angle range of the player is not enough to pay attention to the entire game area, resulting in that the player often needs to move the position for puzzle in the game process, so that the player would expect to tilt the game area towards himself/herself, so as to better access and observe the entire game area. It can be understood, however, that when a plane is obliquely placed, it is easier to turn over, resulting in insufficient stability of the game area. It is a harder dilemma that the process of splicing the jigsaw puzzle cannot be done in one action, and the player often needs to make a corresponding thinking and judgment according to the progress of the game and the picked jigsaw puzzle pieces. Therefore, the player is often expected to be able to press his/her arms against the tabletop to have a brief rest. Unfortunately, conventional jigsaw tables cannot meet such use requirement of the player due to insufficient stability, and the player needs to pay attention to himself/herself to avoid leaning on the table and affecting the stability of the jigsaw table on the tabletop, so that the player is likely to feel uneasy due to his self-constraint, which greatly discounts the game effect.

### SUMMARY OF THE PRESENT INVENTION

An object of the present invention is to provide a puzzle support platform, wherein the puzzle support platform is capable of being stably set up and arranged, so as to provide a steady and rigid game area.

An object of the present invention is to provide a puzzle support platform,

wherein the puzzle support platform is capable of forming a stable triangular configuration so as to be stably supported and placed in position.

An object of the present invention is to provide a puzzle support platform, wherein the puzzle support platform has a platform which is capable of being arranged inclinedly, so that when the platform has puzzle pieces placed thereon, the player's angle of view is able to attend to the puzzle pieces placed on all portions of the platform.

An object of the present invention is to provide a puzzle support platform, wherein the platform has force supporting points reasonably provided for being supported in a stable manner.

An object of the present invention is to provide a puzzle support platform, wherein the puzzle support platform can still be stably supported and placed in position even when the platform is in an inclined state.

An object of the present invention is to provide a puzzle support platform, wherein the platform has one or more force supporting points reasonably provided to prevent being overturned.

An object of the present invention is to provide a puzzle support platform, wherein the puzzle support platform can be stably set up and arranged so that a player can feel freely to perform a puzzle game by means of the puzzle support platform.

An object of the present invention is to provide a puzzle support platform, wherein the platform is allowed to be inclinedly arranged in such a manner that, when the platform has puzzle pieces placed thereon, the player can reach every puzzle piece located at each portion on the platform without the need to move his/her body position.

An object of the present invention is to provide a puzzle support platform, wherein an inclined angle of the platform is configured to be adjustable that allows the player to freely adjust the inclined angle of the platform according to his/her personal gaming habit, so as to ensure the player to perform a pleasant puzzle game.

An object of the present invention is to provide a puzzle support platform, wherein the puzzle support platform is configured to have a detachable structure, such that the puzzle support platform can be disassembled during a collapse operation of the puzzle support platform to facilitate storage and transportation.

According to an aspect of the present invention, the present invention provides a puzzle support platform, wherein the puzzle support platform comprises:
a platform;
a support rod;
a base frame; and
a stabilizing leg, wherein an end of the supporting rod is coupled with the platform, and the other end of the supporting rod is coupled with the base frame through the stabilizing leg, wherein the stabilizing leg, the base frame and the supporting rod are configured to form a stable triangular structure, thereby providing a stable and rigid jigsaw puzzle game area.

Still further objects and advantages will become apparent from a consideration of the ensuing description and drawings.

### BRIEF DESCRIPTION OF THE DRAWINGS

FIG. 1 is a perspective view of a puzzle support platform according to an embodiment of the present invention.

FIG. 2 is an exploded view of the puzzle support platform according to the above embodiment of the present invention.

FIG. 3A is a partially exploded perspective view of the puzzle support platform according to the above embodiment of the present invention, illustrating an assembling of structural elements thereof.

FIG. 3B is a side view of the puzzle support platform of FIG. 3A after being assembled according to the above embodiment of the present invention.

FIG. 4 is a perspective view of a stabilizing leg of the puzzle support platform according to the above embodiment of the present invention.

FIG. 5 is a perspective view of an angle retaining unit of the puzzle support platform according to the above embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

Those skilled in the art should understand that, in the disclosure of the present invention, terminologies of “longitudinal,” “lateral,” “upper,” “front,” “back,” “left,” “right,” “perpendicular,” “horizontal,” “top,” “bottom,” “inner,” “outer,” and etc. just indicate relations of direction or position are based on the relations of direction or position shown in the appended drawings, which is only to facilitate descriptions of the present invention and to simplify the descriptions, rather than to indicate or imply that the referred device or element must apply specific direction or to be operated or configured in specific direction. Therefore, the above-mentioned terminologies shall not be interpreted as confine to the present invention.

It is understandable that the term “a” should be understood as “at least one” or “one or more”. In other words, in one embodiment, the number of an element can be one and in other embodiment the number of the element can be greater than one. The term “a” is not construed as a limitation of quantity.

In the description of the present invention, it should be noted that the terms “mounted,” “connected,” and “linked” should be understood in a general manner, which could be, for example, affixedly connected, detachably connected, or integrally connected. Unless expressly specified and defined otherwise, it may also be a mechanical connection, an electrical connection or may be in communication with each other; it may be directly connected or indirectly connected by means of an intermediate medium, and may be an interaction relationship between two or more elements inside the two elements. For a person of ordinary skill in the art, the specific meanings of the above terms in the present invention may be understood according to specific situations.

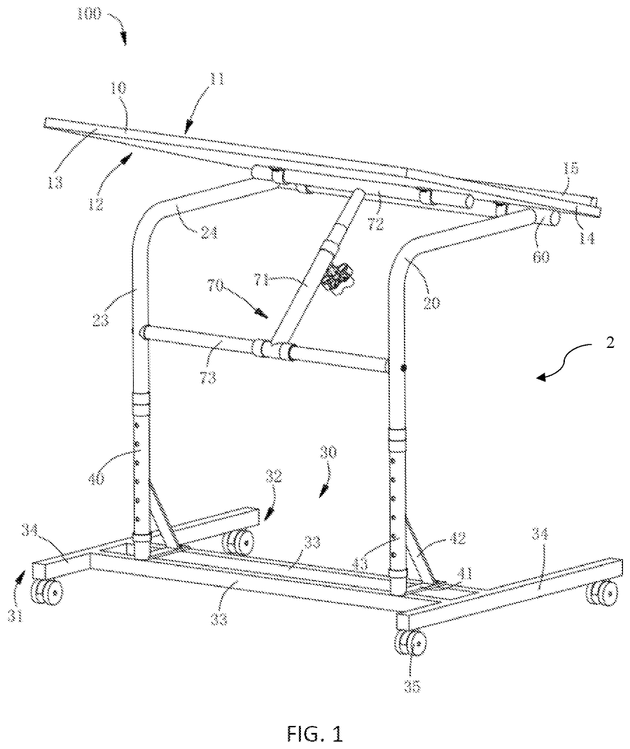

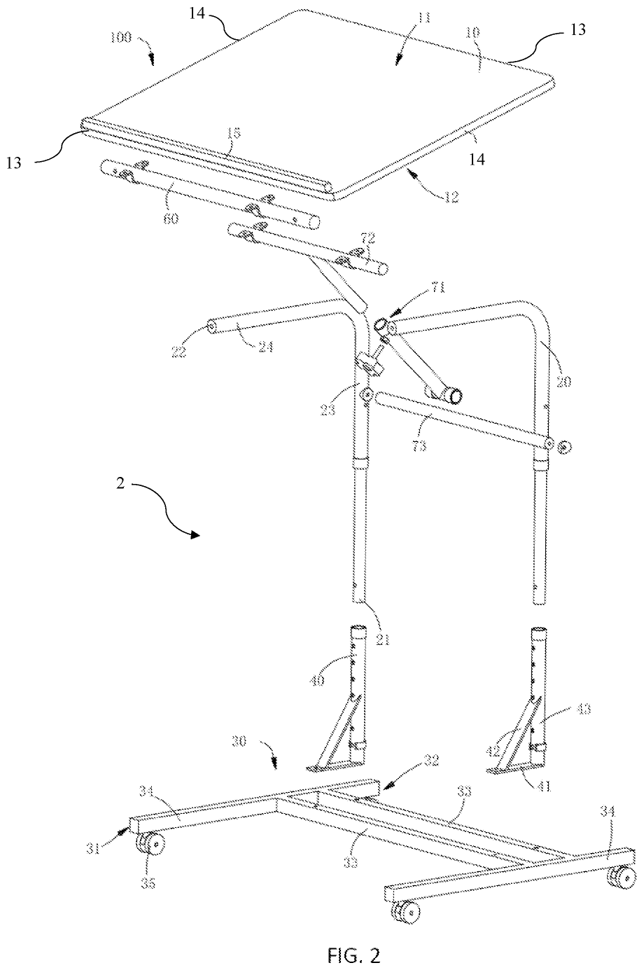

Referring to FIGS. 1-5 of the drawings of the present invention, a puzzle support platform 100 according to an embodiment of the present invention is illustrated, wherein the puzzle support platform 100 allows a player to perform puzzle and put jigsaw puzzle pieces together thereon, wherein the puzzle support platform 100 can be stably set up and arranged to provide a stable and rigid gaming area for the players and improve the game experience of the players.

Specifically, the puzzle support platform 100 comprises a platform 10, a mounting frame 2 and a base frame 30, wherein the mounting frame comprises at least one support rod 20 and at least one stabilizing leg 40 corresponding to the at least one support rod 20. The support rod 20 has a bottom end 21 and a support end 22, wherein the support end 22 of the support rod 20 is coupled with the platform 10 and the bottom end 21 of the support rod 20 is coupled with the base frame 30 through the stabilizing leg to configure a supporting structure for the platform 10, wherein the support rod 20, the base frame 30 and the stabilizing leg 40 may form a polygonal structure. Preferably, the support rod 20, the base frame 30 and the stabilizing leg 40 jointly configure a stable and rigid triangular structure, so as for the puzzle support platform 100 to be stably set up and arranged.

Particularly, the platform 10 is a panel structure. The platform 10 has a top surface 11 and an opposing bottom surface 12. The top surface 11 functions as a jigsaw puzzle baseplate allowing puzzle pieces to be placed thereon, so as for putting the puzzle pieces together thereon. The support rod 20 is coupled with the bottom surface 12. In which, the platform 10 may be embodied in a circular, rectangle or polygonal shape. Specifically, according to the embodiment of the present invention, the platform 10 is embodied in a rectangle shape with two longer lateral sides 13 and two shorter longitudinal sides 14.

It is worth mentioning that the base frame 30 has a front end 31 and a rear end 32. In particular, when the player utilizes the puzzle support platform 100, the player orientation is defined as the front end 31 of the base frame 30 and the end opposite to the front end 31 is the rear end 32, wherein the two lateral sides 13 of the platform 10 are arranged corresponding to the front end 31 and the rear end 32 respectively. Correspondingly, when the player utilizes the puzzle support platform 100, the lateral side 13 close to the rear end 32 is defined as the side facing the player. Therefore, preferably, the support end 22 of the support rod 20 is coupled with the bottom surface 12 of the platform 10 at a position close to the lateral side 13 so as to ensure the platform 10 having a force supporting point in a reasonable mechanics manner, such that when the player press against the platform 10, the downward force applied by the user can be stably supported by the platform 10 to prevent the puzzle support platform 100 from being overturned, so that the player can freely perform the puzzle game on the platform 10.

Particularly, the top surface 11 is arranged to have a predetermined size. The game area size is not smaller than a completion area of the jigsaw puzzle. Preferably, the area size of the top surface 11 matches the completion area of the jigsaw puzzle. For example, the area size of the top surface 11 is arranged to be or slightly larger than the completion area of the jigsaw puzzle of 1000 pieces.

Preferably, the stabilizing leg 40 can jointly configure a stable triangular structure with the support rod 20 and the base frame 30, so as to allow the support rod 20 to stably and rigidly support the platform 10 in position so as to provide the player a stable and steady game area and allow the player to freely and smoothly playing jigsaw puzzle on the platform 10.

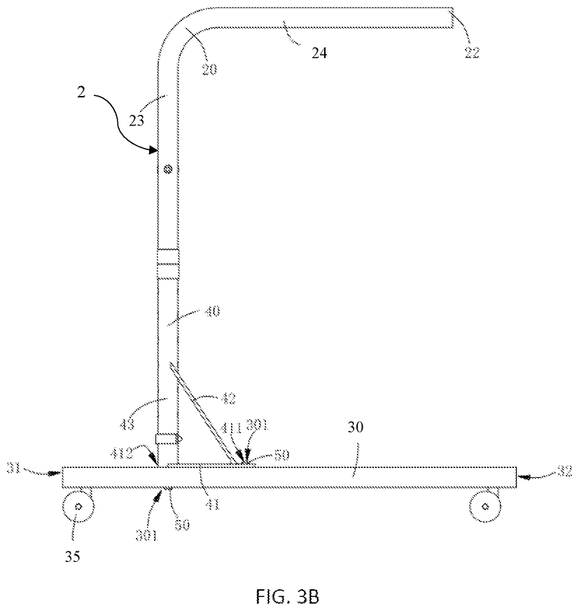

Specifically, referring to FIG. 4, the stabilizing leg 40 includes a longitudinal supporting arm 41 and an oblique supporting arm 42 obliquely extended from the longitudinal supporting arm 41, wherein the longitudinal supporting arm 41 has a first retaining element 411 and a second retaining element 412 arranged on the two ends thereof respectively, wherein an upright vertical line is defined by the second retaining element 412 perpendicular to the longitudinal supporting arm 41, wherein the oblique supporting arm 42 extends inclined from the longitudinal supporting arm 41 towards the upright vertical line to form an included angle between the longitudinal supporting arm 41 and the oblique supporting arm 42.

It should be understood by those skilled in the art that the upright vertical line should be understood as assuming a straight line perpendicularly passing through the longitudinal supporting arm from the second retaining element 42 in a direction perpendicular to the longitudinal supporting arm 41, which construct a structural relation that the upright vertical line at the second retaining element 412 penetrates the longitudinal supporting arm 41, wherein the reference of the upright vertical line is only utilized to describe the shape relationship of the longitudinal supporting arm 41 and the lateral supporting arm 42, and whether there is an actual existence of the upright vertical line in the implementation structure of the stabilizing leg 40 should not constitute limitation to the present invention.

It is worth mentioning that the bottom end 21 of the support rod 20 is coupled with an end of the second retaining element 412 of the longitudinal supporting arm 41, and that while the oblique supporting arm 42 is coupled with the support rod 20 and the bottom end 21 is coupled with the longitudinal supporting arm 41, a rigid structure that the oblique supporting arm 42 is inclined both to the support rod 20 and the longitudinal supporting arm 41 is formed, such that a triangular structure is configured by the support rod 20, the longitudinal supporting arm 41 and the oblique supporting arm 42.

Particularly, the oblique supporting arm 42 is extended from the longitudinal supporting arm 41 at a position of the longitudinal supporting arm 41 close to the first retaining element 411, so as to enhance the stability of the triangular structure constructed by the support rod 20, the longitudinal supporting arm 41 and the oblique supporting arm 42. It is understandable that, if a midpoint of a connecting line between the first retaining element 411 and the second retaining element 412 along the longitudinal supporting arm 41 is a reference point, the first retaining element 411 and the second retaining element 412 are respectively located on two opposing sides of the reference point, such that the position close to the first retaining element 411 means any position located on the side where the first retaining element 411 is located. Preferably, the oblique supporting arm 42 extends from the longitudinal supporting arm 41 at a position adjacent to the first retaining element 411.

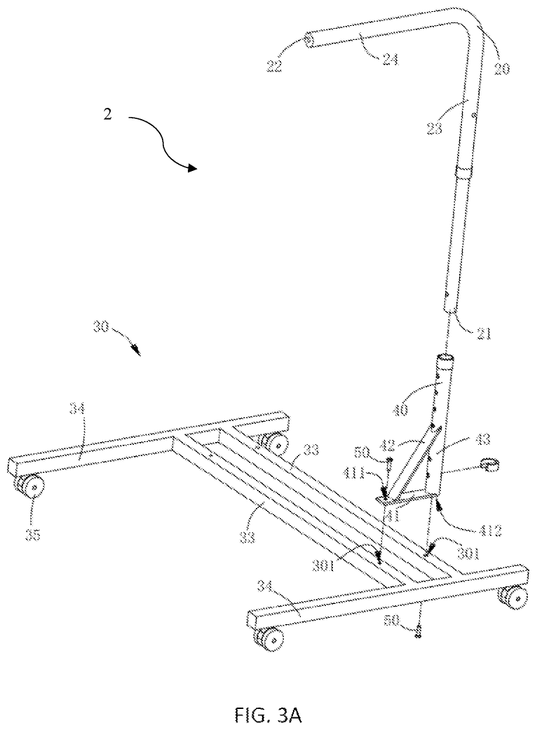

It is worth mentioning that the base frame 30 comprises at least a pair of mounting position members 301. Referring to FIGS. 3A and 3B, the stabilizing leg 40 is affixed to the base frame 30 in a manner that the first retaining element 411 and the second retaining element 412 of the longitudinal supporting arm 41 are directly positioned on the same pair of the mounting position members 301, so as to construct a configuration that the support rod 20 is coupled with the base frame 30 through the stabilizing leg 40, that is to utilize the stabilizing leg 40 to construct the stable and rigid triangular structure through the support rod 20, the base frame 30 and the stabilizing leg 40.

Furthermore, in order to facilitate the support rod 20 to be accurately coupled with the stabilizing leg 40 to form a structural relationship that the support rod 20 is abutted against the supporting end 421 of the oblique supporting arm 42 and is coupled with the end of the second retaining element 412 of the longitudinal supporting arm 41, the stabilizing leg 40 further comprises a tubular vertical mounting post 43, wherein the vertical mounting post 43 extends from the end of the longitudinal supporting arm 41 wherein the second retaining element 412 located towards the supporting end 421 of the oblique supporting arm 42 and coupled with the supporting end 421 of the oblique supporting arm 42, wherein the vertical mounting post 43 has a retaining space 431 defined therein and configured for the support rod 20 being inserted and mounted in the retaining space 431, so as to form the structural relationship that the support rod 20 is abutted against the supporting end 421 of the oblique supporting arm 42 and coupled with the end of the second retaining element 412 of the longitudinal supporting arm 41, that ensures the structural stability of the support rod 20 being coupled with the stabilizing leg thereby facilitating the assembling of the puzzle support platform 100.

Preferably, the vertical mounting post 43 is perpendicular to the longitudinal supporting arm 41 and is mounted in the manner perpendicular to the oblique supporting arm 42 in correspondence to the support rod 20, which benefits and ensures the stability of the triangular structure formed by the support rod 20, the base frame 30, and the stabilizing leg 40.

It is worth mentioning that the vertical mounting post 43 has a row of positioning holes 433, wherein the positioning holes 433 are evenly and spacingly aligned and arranged along the vertical mounting post 43. The vertical mounting post 43 further comprises a height member 432, wherein the height member 432 is capable of being positioned at one of the positioning holes 433 so as for mounting the support rod 20 in the retaining space 431. In other words, a player may, based on various needs, position the height member 432 at different position holes 433 of the row of positioning holes 433 to adjust a depth of the support rod 20 to be inserted into the retaining space 431, so as to achieve a height adjustment of the puzzle support platform 100.

Preferably, according to the embodiment of the present invention, two opposing rows of positioning holes 433 are formed along two opposing sides of the vertical mounting post 43 symmetrically, such that the height member 432 is allowed to be mounted on two of the positioning holes 431 of the same height among these two rows of the positioning holes 431, so as to ensure the stability of the mounting of the support rod 10.

Particularly, it is preferable in the embodiment of the present invention that the stabilizing leg 40 is specifically detachably mounted on the base frame 30 and the support rod 20 is also detachably coupled with the stabilizing leg 40 and the platform 10. In other words, the components of the puzzle support platform 100 are all configured in a detachable manner, such that during a disassembling operation of the puzzle support platform 100, the puzzle support platform 100 is correspondingly disassembled to reduce a volume thereof for storage and transportation so as to facilitate the storing and carrying of the puzzle support platform 100.

Further, the detachable connection between the stabilizing leg 40 and the base frame 30 can be embodied in various manners. For example, the stabilizing leg 40 may be detachably mounted on the base frame 30 in a magnetic attachment manner. In other words, the stabilizing leg 40 and the base frame 30 are capable of generating magnetic force to attach with each other, so that when the stabilizing leg 40 approaches the base frame 30, the stabilizing leg 40 can be affixed to the base frame 30.

According to the embodiment of the present invention, specifically, the puzzle support platform 100 further comprises at least a pair of the connectors 50, wherein the stabilizing leg 40 and the base frame 30 are connected by means of the connectors 50. Specifically, the first retaining element 411 and the second retaining element 412 are embodied as perforations formed in the longitudinal supporting arm 41 and the mounting position members 301 are indentions embodied as holes or slots formed in the base frame wherein one of the connectors 50 is penetratingly arranged in the first retaining element 411 and the mounting position member 301 of the base frame 30 positioned corresponding to the first retaining element 411, while the other connector 50 is penetratingly arranged on the second retaining element 412 and the mounting position member 301 of the base frame 30 positioned corresponding to the second retaining element 412, so as to form the structural state of mounting the stabilizing leg 40 to base frame 30, and provide a position retaining limitation to mount the stabilizing leg 40 on the base frame 30. Hence, the detachable mounting of the stabilizing leg 40 on the base frame 30 is simply achieved.

It is understandable that the implementations of the connectors 50 shall not limit the present invention. For example, the connectors 50 may be embodied as a screw, so as for achieving the connection between the stabilizing leg 40 and the base frame 30. For another example, the connectors 50 may also be embodied as engagement of bolt and nut, and etc., that the present invention shall not be limited here.

Further, the base frame 30 comprises two lateral rods 33 and two longitudinal rods 34, wherein the longitudinal rods 34 are respectively arranged on the two ends of each of the lateral rods 33 to form an H-shape structure. In other words, the two longitudinal rods 34 are arranged and aligned in a parallel manner, while the lateral rods 34 is arranged between the two longitudinal rods 34 in the manner that the two ends of the lateral rods 33 are respectively connected with the longitudinal rods 34 while the two lateral rods 33 are arranged parallel to each other. When the player is utilizing the puzzle support platform 100, the lateral rods 33 are laterally arranged in front of the player. Correspondingly, the two ends of the longitudinal rods 34 are respectively the front end 31 and the rear end 32 of the base frame 30. Preferably, a distance between the front end 31 and a midpoint of a connecting line between the two lateral rods 33 along the longitudinal rods 34 is preferred to be one third of the total length of the longitudinal rod 34, so as to ensure a balance of a weight of the puzzle support platform 100 and the force applied to the puzzle support platform 100 and thus to ensure the stability of the puzzle support platform 100.

Specifically, the mounting position members 301 of the base frame 30 are respectively arranged on the two lateral rods 33. Namely, one of the mounting position members 301 is arranged on one of the lateral rods 33, while the other mounting position member 301 is arranged on the other lateral rod 33. A connecting line between the two mounting position members 301 of the same pair is parallel to the longitudinal rods 34 so as to ensure the base frame 30, the stabilizing leg 40 and the support rod 10 being able to form the stable and rigid triangular structure.

It is worth mentioning that the mounting position members 301 are respectively arranged on the two lateral rods 33 and the connecting line between the mounting position members 301 of the same pair is parallel to the longitudinal rods 34, so that a spacing between the two lateral rods 33 is equal to a spacing between the two mounting position members 301, that correspondingly equals to a distance between the first retaining element 411 and the second retaining element 412. Therefore, it is understandable that, the distance between the two lateral rods 33 relates to the stability of the puzzle support platform 100, and preferably, according to the embodiment of the present invention, the two lateral rods 33 have the spacing of 100 mm within an error range of 20%, so that a sufficient foot moving space for the player can be achieved while the base frame 30, the stabilizing leg 40 and the support rod 10 form the stable and rigid triangular structure. That is, the distance between the two lateral rods 33 is kept in a suitable range, so that the two lateral rods 33 are prevented from occupying an overly large area, avoiding the lateral rod 33 from creating an impediment to the moving space of the player, so that the player can play the puzzle game more freely.

In particular, the base frame 30 further comprises four wheels 35, wherein two of the wheels 35 are spacingly arranged below one of the longitudinal rods 34, while the other two wheels 35 are spacingly arranged below the other longitudinal rod 34, so that the puzzle support platform 100 can be easily moved with the wheels 35. Optionally, according to some embodiments, the wheels 35 are replaced with an anti-slip mat, which may be made of material such as rubber and etc., so as to buffer wear of the puzzle support platform 100 to the ground.

Preferably, in order to ensure a supporting stability of the platform 10, a pair of the support rods 20 is configured and a pair of corresponding stabilizing legs 40 is also configured correspondingly, so that the stability of the platform 10 is ensured based on the two support rods 20 forming the stable and rigid triangular structure with the base frame 30 and the corresponding stabilizing legs 40.

It is worth mentioning that the support rod 20 has a bent configuration that extends from its bottom end 21 in a direction away from the base frame 30 to form a vertical section 23 and then extends to its support end 22 in a direction from the rear end 32 towards the front end 31 of the base frame 30 to form an extending section 24, wherein the vertical section 23 is perpendicular to the base frame 30 and the extending section 24 is perpendicularly extending from the vertical section 23. Correspondingly, with respect to the extending section 24 in parallel to the longitudinal rod 34 of the base frame 30, the vertical section 23 is perpendicular to the longitudinal supporting arm 41 of the stabilizing leg 40 and the extending section 24 is parallel to the longitudinal supporting arm 41 of the stabilizing leg 40. In which, the vertical section 23 is mounted in the retaining space 431 of the vertical mounting post 43, wherein the support ends 22 of the two support rods 20 are coupled with a mounting rail 60. The platform 10 is mounted on the mounting rail 60 so as to couple with the pair of support rods 20.

Particularly, according to the embodiment of the present invention, the mounting rail 60 is pivotally mounted along the front lateral side 13 of the platform 10 that is positioned above the front end 31 of the base frame 30 so as to mount the platform to the mounting rail 60. That is the mounting rail 60 is arranged parallel to the front lateral side 13 of the platform 10 while the vertical sections 23 of the pair of support rods are upwardly extended above the rear end 32 of the base frame 30 so as to provide a balance configuration for well support the platform 10 in various orientations, including a horizontal state and an inclined state with a desired included angle. Accordingly, the supporting force of the mounting frame 2 to the platform 10 can be concentrated on the front lateral side 13 of the platform 10 so as to allow the platform 10 to have a reasonable force supporting point, especially while the platform 10 is adjusted in the inclined state.

Preferably, the platform 10 is pivotally arranged on the mounting rail 60 for pivoting about the mounting rail 60 as a pivot axis, such that the platform 10 can be inclinedly arranged that allows the top surface 11 of the platform 10 inclinedly facing toward the player. Accordingly, when the top surface 11 has puzzle pieces placed thereon, the player's angle of view can cover all the puzzle pieces located at every portion of the top surface 11. Besides, when the top surface 11 faces toward the player, it allows the player to reach each puzzle piece placed on the top surface 11 of the platform 10 without moving his/her body position in order to enhance the player's game experience of the puzzle game.

Particularly, the supporting force of the mounting frame 2 to the platform 10 is applied to the front lateral side 13 of the platform 10 above the front side 31 of the base frame 30. Therefore, when the top surface 11 of the platform 10 being inclinedly adjusted to face toward the player, the supporting of the mounting frame 2 to the platform 10 is positioned at a lower position of the platform 10, so that the platform 10 can have the force supporting point in a reasonable manner that, when the player presses against the platform 10, the platform 10 is stably supported and thus can be prevented from being overturned, so that the player can feel freely to perform the puzzle game on the platform 10.

It is worth mentioning that the support rod 20, the base frame 30 and the stabilizing leg 40 constructed the stable and rigid triangular structure, so that when the platform 10 is allowed to be inclinedly arranged, the stable triangular structure enables the puzzle support platform 100 to be stably set up and arranged without overturning, thereby ensuring a smooth progress of the puzzle game.

In particular, the player can adjust an inclination angle of the top surface 11 through a pivoting configuration of the platform 10 with the mounting frame 2, so that the puzzle support platform 100 can allow the player to flexibly adjust the inclination angle of the top surface 11 based on their personal game habits, that enables the player to pleasantly perform the jigsaw game.

It is worth mentioning that the platform 10 further comprises a boundary wall 15 extended from a periphery or a part of the periphery of the top surface 11 towards a direction away from the bottom surface 12, so as to prevent the puzzle pieces placed on the top surface 11 from falling off the top surface 11. According to the embodiment of the present invention, the boundary wall 15 extends from the periphery of the top surface 11 close to the front lateral side 13 towards the direction away from the bottom surface 12, so as to block the puzzle pieces placed on the top surface 11 from falling.

In particular, the top surface 11 may be configured as a rough surface to improve the static friction generated between the top surface 11 and the puzzle pieces placed thereon, so that the puzzle pieces placed on the top surface 11 can be stably positioned. For example, the top surface 11 may have an anti-skid flannelette layer covered thereon.

It is understandable that, when the player adjusts the inclination angle of the top surface 11 to a suitable inclined state, the inclination angle of the top surface 11 is expected to remain fixed. Therefore, to retain the platform 10 at a predetermined pivot angle is also crucial for the game experience of the player.

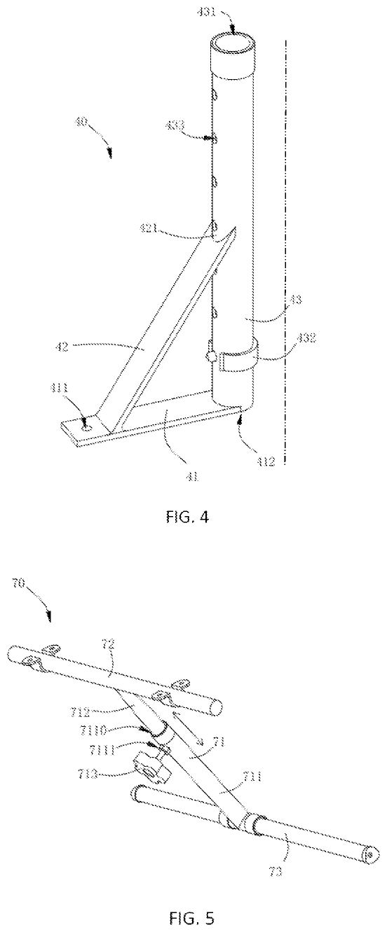

Accordingly, referring to FIG. 5, the mounting frame 2 further comprises a means for adjusting an inclined angle of the platform 10, which is embodied as a retaining assembly 70 in the embodiment, wherein the retaining assembly 70 comprises a telescopic rod 71, a first holding rod 72 and a second holding rod 73, wherein the first holding rod 72 is arranged on the bottom surface 12 of the platform 10, and two ends of the second holding rod 73 are respectively coupled with the vertical sections 23 of the two support rods 20 in an equal-height manner, wherein two ends of the telescopic rod 71 are respectively coupled with the first holding rod 72 and the second holding rod 73, wherein a length of the telescopic rod 71 is maintainable and adjustable, wherein a length change of the telescopic rod 71 can correspondingly form a relative movement of the first holding rod 72 and the second holding rod 73 to increase or decrease a distance therebetween, so as to change a position relationship between the bottom surface 12 of the platform 10 and the vertical sections 23 of the support rods 20, so that when the length of the telescopic rod 71 is maintained, the position relationship between the bottom surface 12 of the platform 10 and the vertical section 23 of the support rod 20 is correspondingly retained, and the inclination angle of the top surface 11 is retained as well.

It is worth mentioning that, when the length of the telescopic rod 71 is in a retained state, the telescopic rod 71 further forms a support for the platform 10. Accordingly, based on the structural relation of an end of the telescopic rod 71 being connected with the first holding rod 72 while the support ends 22 of the support rods 20 being connected with the mounting rail 60, a support is provided to the platform 10 by means of the first holding rod 72 and the mounting rail 60, that concentrates the supporting force applied to the platform 10 to a middle of the first holding rod 72 and the mounting rail 60. Correspondingly, the supporting force applied to the platform 10 is concentrated to the front lateral side 13 of the platform 10 above the front end 31 of the base frame 30, so that the platform 10 has sufficient support at the front lateral side 13 of the platform 10 that faces the player, so as to ensure the stability of the puzzle support platform 100.

Specifically, the telescopic rod 71 comprises an outer sleeve 711, an inner pipe 712 and a holding knob 713, wherein the outer sleeve 711 has a telescopic channel 7110 therein, wherein the inner pipe 712 is inserted in the telescopic channel 7110 of the outer sleeve 711 in a movable manner along an extending direction of the telescopic channel 7110 so as to adjust the length of the telescopic rod 71, wherein a side wall of the outer sleeve 711 is provided with a threaded knob hole 7111 communicating with the telescopic channel 7110, wherein the holding knob 713 is screwed through the knob hole 711 to enter the telescopic channel 7110 such that a degree of the holding knob 713 entering the telescopic channel 7110 is adjustable, so as to control a movement of the inner pipe 712 when the holding knob 713 pressed against the inner pipe 712. In other words, the player can adjust the degree of the holding knob 713 entering the telescopic channel 7110 through rotating the holding knob 713, and that when the holding knob 713 is adjusted to a deep entering state into the telescopic channel 7110, the holding knob 713 presses against the inner pipe 712 to prevent the inner pipe 712 from moving in the telescopic channel 7110, so that the length of the telescopic rod 71 is retained.

In particular, according to some embodiments, the telescopic rod 71 is implemented as an electric telescopic rod for electrically driving the relative movement of the first holding rod 72 and the second holding rod 73, so that the inclination angle of the top surface 11 can be adjusted in an electrical power-driven manner, which allows the player to adjust the inclination angle of the top surface 11 more easily.

One skilled in the art will understand that the embodiment of the present invention as shown in the drawings and described above is exemplary only and not intended to be limiting. It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

1: A puzzle support platform for playing puzzle having a plurality of puzzle pieces, comprising:
a platform, having a top surface for placing the puzzle pieces thereon and an opposing bottom surface;
a mounting frame which comprises:
at least one support rod, having a bottom end and a support end coupled with said bottom surface of said platform; and
at least one stabilizing leg comprising a longitudinal supporting arm and an oblique supporting arm, wherein said longitudinal supporting arm has a first retaining element and a second retaining element respectively formed at two ends thereof, wherein said bottom end of said supporting rod is coupled with an end of said second retaining element of said longitudinal supporting arm, wherein said oblique supporting arm is extended from said longitudinal supporting arm towards said support rod and coupled with said support rod, such that said oblique supporting arm is inclinedly supported between said support rod and said longitudinal supporting arm; and
a base frame comprising at least one pair of mounting position members, wherein said at least one stabilizing leg is affixed to said base frame in a manner that said first retaining element and said second retaining element of said longitudinal supporting arm are respectively coupled with said at least one pair of mounting position members so as to support said at least one support rod by means of said at least one stabilizing leg, such that said support rod, said base frame and said stabilizing leg are configured to form a triangular structure.

2: The puzzle support platform, as recited in claim 1, wherein said at least one stabilizing leg comprises a tubular vertical mounting post, having a retaining space therein, extended from said second retaining element of said longitudinal supporting arm, wherein an upper end of said oblique supporting arm is coupled with said vertical mounting post and said bottom end of said at least one support rod is inserted in said retaining space of said vertical mounting post so as to couple said at least one support rod with said base frame.

3: The puzzle support platform, as recited in claim 2, wherein said vertical mounting post is perpendicular to said longitudinal supporting arm and said oblique supporting arm is extended from said longitudinal supporting arm at a position that is close to the first retaining element of the longitudinal supporting arm.

4: The puzzle support platform, as recited in claim 2, wherein said vertical mounting post has at least one row of positioning holes spacedly and internally provided therealong, wherein a height member is positioned at one of said at least one row of positioning holes to limit a depth of said support rod to be inserted in said retaining space of said vertical mounting post.

5: The puzzle support platform, as recited in claim 4, wherein said puzzle support platform further comprises connectors to connect said first retaining element and said second retaining element of said longitudinal supporting arm with said mounting position members of said base frame respectively.

6: The puzzle support platform, as recited in claim 1, wherein said base frame comprises two lateral rods and two longitudinal rods aligned in a parallel manner, wherein said lateral rods are arranged between said longitudinal rods and two ends of each of said lateral rods are respectively connected with said two longitudinal rods, wherein one of said pair of mounting position members is arranged on one of said lateral rods while another one of said pair of mounting position members is arranged on another one of said lateral rods.

7: The puzzle support platform, as recited in claim 1, further comprises a mounting rail which is coupled to said support end of said at least one support rod and pivotally mounted along a front lateral side of said platform so as to pivotally mount said platform on said mounting frame, wherein said mounting frame further comprises a means for adjusting an inclination angle of said platform.

8: A puzzle support platform for playing puzzle having a plurality of puzzle pieces, comprising:
a platform, having a top surface for placing the puzzle pieces thereon and an opposing bottom surface;
a mounting frame which comprises:
a pair of support rods, each having a bottom end, a support end, a vertical section extended from said bottom end, and an extending section frontwardly extended from said vertical section to said support end; and
a pair of stabilizing legs each comprising a longitudinal supporting arm and an oblique supporting arm, wherein said longitudinal supporting arm has a first retaining element and a second retaining element respectively formed at two ends thereof, wherein said bottom ends of said support rods are coupled with ends of said second retaining elements of said longitudinal supporting arms, wherein said oblique supporting arms are extended from said longitudinal supporting arms towards said support rods and coupled with said support rods respectively, such that said oblique supporting arms are inclinedly supported between said support rods and said longitudinal supporting arms respectively; and
a base frame comprising two pairs of mounting position members, wherein said stabilizing legs are affixed to said base frame in a manner that said first retaining elements and said second retaining elements of said longitudinal supporting arms are respectively coupled with said mounting position members so as to support said support rods by means of said stabilizing leg respectively, such that said support rod and said stabilizing leg are configured to form a triangular structure with said base frame.

9: The puzzle support platform, as recited in claim 8, wherein each of said stabilizing legs comprises a tubular vertical mounting post, having a retaining space therein, extended from said second retaining element of said longitudinal supporting arm, wherein upper ends of said oblique supporting arms are coupled with said vertical mounting posts and said bottom ends of said support rods are inserted in said retaining spaces of said vertical mounting posts respectively so as to couple said support rods with said base frame.

10: The puzzle support platform, as recited in claim 9, wherein said vertical mounting posts are respectively perpendicular to said longitudinal supporting arms and said oblique supporting arms are respectively extended from said longitudinal supporting arms at positions that are close to the first retaining elements of the longitudinal supporting arms.

11: The puzzle support platform, as recited in claim 9, wherein each of said vertical mounting posts has at least one row of positioning holes spacedly and intervally provided therealong, wherein a height member is positioned at one of said at least one row of positioning holes to limit a depth of said support rod to be inserted in said retaining space of said vertical mounting post.

12: The puzzle support platform, as recited in claim 11, wherein said puzzle support platform further comprises connectors to connect said first retaining elements and said second retaining elements of said longitudinal supporting arms with said mounting position members of said base frame respectively.

13: The puzzle support platform, as recited in claim 8, wherein said base frame comprises two lateral rods and two longitudinal rods aligned in a parallel manner, wherein said lateral rods are arranged between said longitudinal rods and two ends of each of said lateral rods are respectively connected with said two longitudinal rods, wherein said mounting position members are arranged on said lateral rods respectively.

14: The puzzle support platform, as recited in claim 8, further comprises a mounting rail which is coupled to said support ends of said support rods and pivotally mounted along a front lateral side of said platform so as to pivotally mount said platform on said mounting frame, wherein said mounting frame further comprises a means for adjusting an inclination angle of said platform.

15: The puzzle support platform, as recited in claim 14, wherein said adjusting means comprises a retaining assembly, which comprises a telescopic rod, a first holding rod and a second holding rod, wherein two ends of said first holding rod are coupled with said vertical sections of the two said support rods in an equal-height manner, wherein said second holding rod is disposed on said bottom surface of said platform, wherein said two ends of said telescopic rod are respectively coupled with said first holding rod and said second holding rod, wherein a length of said telescopic rod is maintainable and adjustable so as for adjusting the inclination angle of said platform.

16: A puzzle support platform for playing puzzle having a plurality of puzzle pieces, comprising:
a base frame having a front end and a rear end;
a platform, having two longer lateral sides, two shorter longitudinal sides, a top surface for placing the puzzle pieces thereon and an opposing bottom surface;
a mounting frame, which comprises:
a pair of support rods each having a support end, a bottom end coupled with said base frame, a vertical section extended from said bottom end, and an extending section frontwardly extended from said vertical section to said support end; and
a retaining assembly which comprises a telescopic rod and a first holding rod, wherein two ends of said first holding rod are respectively coupled with said vertical sections of said support rods in an equal-height manner, wherein one end of said telescopic rod is coupled with said first holding rod and another end of said telescopic rod is coupled with said bottom surface of said platform, wherein a length of said telescopic rod is maintainable and adjustable so as for adjusting the inclination angle of said platform; and
a mounting rail coupled to said support ends of said support rods and pivotally mounted along a front lateral side of aid platform so as to pivotally mount said platform on said mounting frame.

17: The puzzle support platform, as recited in claim 16, wherein said retaining assembly of said mounting frame further comprises a second holding rod wherein said second holding rod is mounted on said bottom surface of said platform in a manner parallel to said first holding rod, such that said another end of said telescopic rod is connected to said second holding rod so as to couple with said platform.

18: The puzzle support platform, as recited in claim 17, wherein said bottom end of said support rod is coupled with said base frame in a manner that is leaned toward said front end.

19: The puzzle support platform, as recited in claim 18, wherein said mounting frame further comprises a pair of stabilizing legs, wherein each of said stabilizing legs comprises a longitudinal supporting arm and an oblique supporting arm, wherein said longitudinal supporting arm has a first retaining element and a second retaining element respectively formed at two ends thereof, wherein said bottom ends of said support rods are coupled with ends of said second retaining elements of said longitudinal supporting arms, wherein said oblique supporting arms are extended from said longitudinal supporting arms towards said support rods and coupled with said support rods respectively, such that said oblique supporting arms are inclinedly supported between said support rods and said longitudinal supporting arms respectively, thereby said support rod and said stabilizing leg are configured to form a triangular structure with said base frame.

20: The puzzle support platform, as recited in claim 19, wherein each of said stabilizing legs comprises a tubular vertical mounting post, having a retaining space therein, extended from said second retaining element of said longitudinal supporting arm, wherein upper ends of said oblique supporting arms are coupled with said vertical mounting posts and said bottom ends of said support rods are inserted in said retaining spaces of said vertical mounting posts respectively so as to couple said support rods with said base frame.
